(19) United States
(12) Patent Application Publication
(10) Pub. No.: US 2007/0156566 A1
(43) Pub. Date: Jul. 5, 2007

(54) System and method for seller and item filters

(75) Inventors: Adam Nash, Sunnyvale, CA (US); Josh Loftus, San Jose, CA (US); Daniel Silver, Los Altos, CA (US); David Raccah, San Jose, CA (US)

Correspondence Address: SCHWEGMAN, LUNDBERG, WOESSNER & KLUTH/EBAY, P.O. BOX 2938, MINNEAPOLIS, MN, 55402, US

(73) Assignee: EBAY INC., SAN JOSE, CA (US)

(21) Appl. No.: 11/323,792

(22) Filed: Dec. 30, 2005

(51) Int. Cl. G06Q 40/00

(52) U.S. Cl. 705/37

(57) ABSTRACT

A system and method uses seller and item filters to identify items listed on a network based transaction facility that are qualified for a network based elite transaction facility.

### TECHNICAL FIELD

Various embodiments relate generally to the fields of network-based transaction facilities and commerce automation, and in particular, but not by way of limitation, to a system and method for applying seller and item filters in a network-based transaction facility.

### BACKGROUND

The Internet and the World Wide Web provide access to a tremendous amount of products and information. Many sites on the World Wide Web are referred to as E-commerce sites that permit a user to log on to the site, shop for items and services online, add the items and services desired to be purchased into an electronic shopping cart, submit the order to the E-commerce facility's server, and have the items delivered to the user. In a typical E-commerce site, a user searches for an item, then sorts through multiple sellers of the item to identify a suitable seller. The user then places a bid for the item, or submits an order with payment for the item in his electronic shopping cart. If the user places an order, the E-commerce server accepts and fills that order for all the items in the cart that are presently available.

### BRIEF DESCRIPTION OF THE DRAWINGS

Example embodiments of the present invention are illustrated by way of example and not limitation in the figures of the accompanying drawings, in which like references indicate similar elements and in which:

FIG. 1 is a block diagram illustrating an example network-based transaction facility.

FIG. 2 is a database diagram illustrating an example database for the network-based transaction facility of FIG. 1.

FIG. 3 is a diagrammatic representation of an example transaction record table of the database illustrated in FIG. 2.

FIG. 4 is a diagrammatic representation of an example item database.

FIG. 5 is a diagrammatic representation of an example shopping cart database.

FIG. 6 is a block diagram illustrating another example network-based transaction facility.

FIG. 7 illustrates a flowchart of a process that may be used in connection with the network-based transaction facility of FIG. 6.

FIG. 8 illustrates an example computer system upon which one or more order processing and confirmation embodiments may execute.

### DETAILED DESCRIPTION

A system and method for seller and item filters in an online environment are described. In the following description, for purposes of explanation, numerous specific details are set forth in order to provide a thorough understanding of the present invention. It will be evident, however, to one skilled in the art that the present invention may be practiced without these specific details.

### Terminology

For the purposes of the present specification, the term “transaction” shall be taken to include any communications between two or more entities and shall be construed to include, but not be limited to, commercial transactions including sale and purchase transactions, auctions and the like.

### Transaction Facility

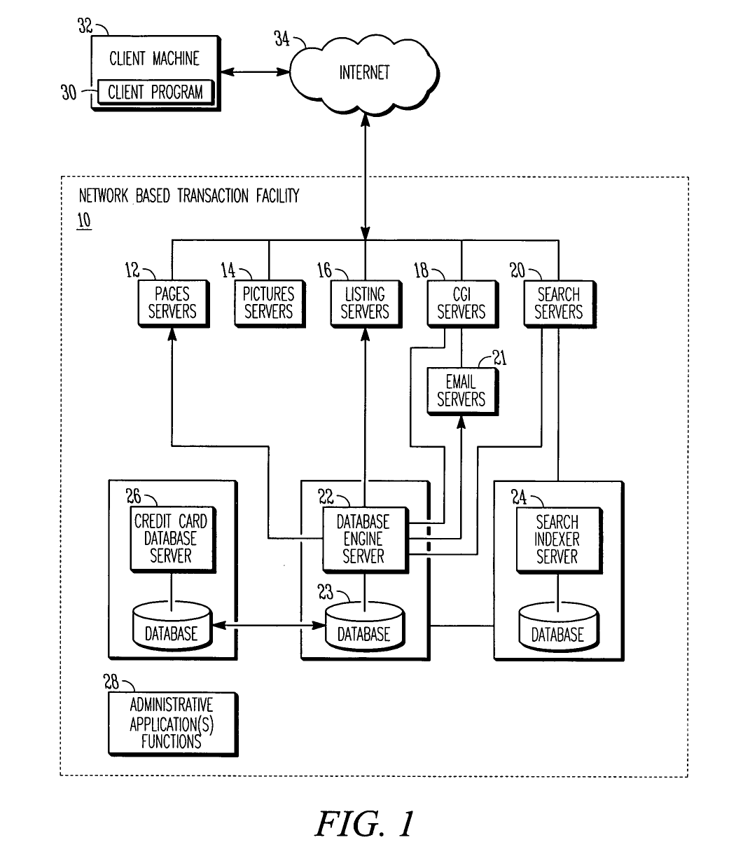

FIG. 1 is block diagram illustrating an example network-based transaction facility 10 that includes one or more of a number of types of front-end servers, namely page servers 12 that deliver web pages (e.g., markup language documents), picture servers 14 that dynamically deliver images to be displayed within Web pages, listing servers 16, CGI (or ISAPI) servers 18 that provide an intelligent interface to the back-end of facility 10, and search servers 20 that handle search requests to the facility 10. E-mail servers 21 provide, inter alia, automated e-mail communications to users of the facility 10.

The back-end servers include a database engine server 22, a search index server 24 and a credit card database server 26, each of which maintains and facilitates access to a respective database.

The facility 10 may be accessed by a client program 30, such as a browser (e.g., the Internet Explorer distributed by Microsoft Corp. of Redmond, Wash.) that executes on a client machine 32 and accesses the facility 10 via a network such as, for example, the Internet 34. Other examples of networks that a client may utilize to access the auction facility 10 include a wide area network (WAN), a local area network (LAN), a wireless network (e.g., a cellular network), or the Plain Old Telephone Service (POTS) network.

### Database Structure

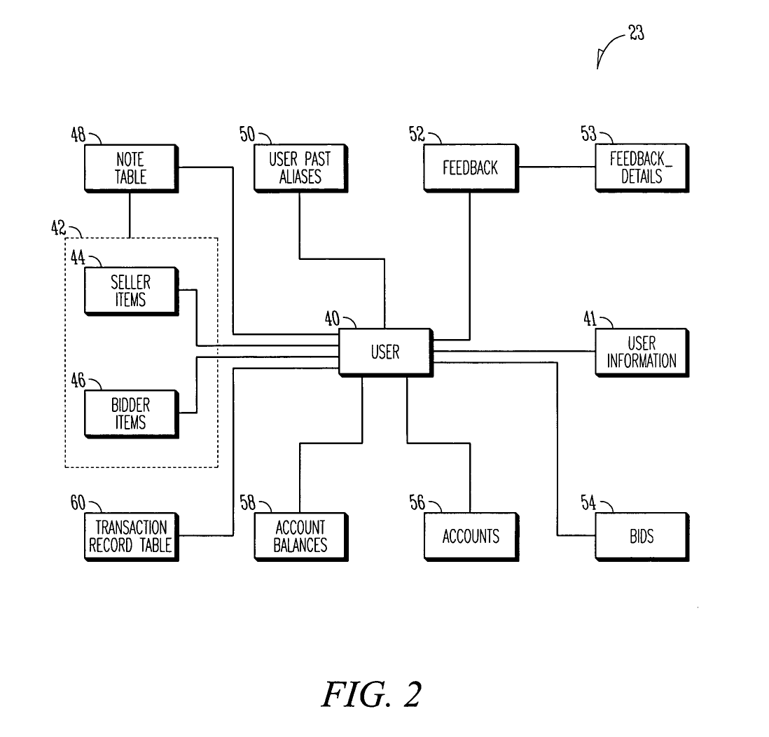

FIG. 2 is a database diagram illustrating an example database 23, maintained by and accessed via the database engine server 22, which at least partially implements and supports the network-based transaction facility 10 such as an Internet-based auction facility, an E-commerce facility, a network-based payment service provider, and/or a network-based publication facility.

The database 23 may, in one embodiment, be implemented as a relational database, and may include a number of tables having entries, or records, that are linked by indices and keys. In an alternative embodiment, the database 23 may be implemented as a collection of objects in an object-oriented database.

Central to the database 23 is a user table 40, which contains a record for each user of the network-based transaction facility 10. A user may operate as a seller, a buyer, or both, within the facility 10. The database 23 also includes item tables 42 that may be linked to the user table 40. Specifically, the tables 42 include a seller items table 44 and a bidder items table 46. A user record in the user table 40 may be linked to multiple items that are being, or have been, auctioned via the facility 10. A link indicates whether the user is a seller or a buyer with respect to items for which records exist within the item tables 42. The database 23 also includes a note table 48 populated with note records that may be linked to one or more item records within the item tables 42 and/or to one or more user records within the user table 40. Each note record within the table 48 may include, inter alia, a comment, description, history or other information pertaining to an item being offered via the facility 10, or to a user of the facility 10.

A number of other tables are also shown to be linked to the user table 40, namely a user past aliases table 50, a feedback table 52, a feedback details table 53, a bids table 54, an accounts table 56, an account balances table 58 and a transaction record table 60.

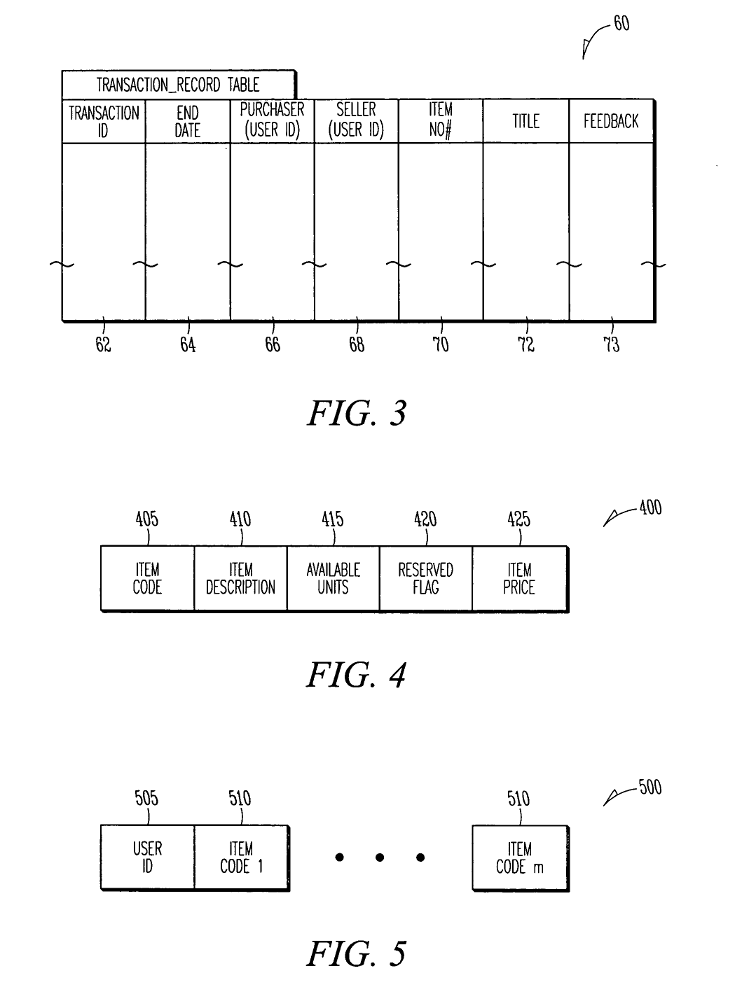

FIG. 3 is a diagrammatic representation of an example embodiment of the transaction record table 60 that is populated with records, or entries, for completed, or ended, transactions that have been facilitated by the facility 10. The table 60 includes a transaction identifier column 62 that stores a unique transaction identifier for each entry, and an end date column 64 that stores a date value indicating, for example, a date on which a transaction was established. A purchaser column 66 stores a user identifier for a purchaser, the user identifier comprising a pointer to further user information stored in the user table 40. Similarly, a seller column 68 stores, for each entry, a user identifier for a seller within the relevant transaction. An item number column 70 stores, for each entry, an item number identifying the goods or service being transacted, and a title column 72 stores, for each entry, a descriptive title for the relevant transaction or for the item being transacted. A feedback column 73 stores, for each entry, data specifying whether feedback exists for the relevant transaction and whether this feedback is current (i.e., has not been removed or withdrawn).

It should be noted that, in one embodiment, an entry is only created in the transaction record table 60 for transactions that have been established by some offer and acceptance mechanism between the purchaser and the seller.

FIG. 4 illustrates an example embodiment of an item data base 400. In an embodiment, the seller items table 44 of FIG. 2 uses this structure. Referring to FIG. 4, the item database 400 includes an item identifier or code 405, an item description 410, an available units field 415, a reserved flag 420, and an item price field 425. FIG. 5 illustrates an example embodiment of a shopping cart database record 500. The shopping cart database record includes a user id code 505, and one or more item identifiers or codes 510 corresponding to each item that a user has placed into his cart. The item identifier field may be used to relate each item in a user's shopping cart to the record for that item in the item database 400.

### Elite Transaction Facility

Within a network-based transaction facility for sellers to list items for sale, filters are used to select a subset of sellers and their items for participation in an elite transaction based facility. In one embodiment, the network-based transaction facility provides an auction environment for buyers to place bids on items that they wish to purchase from sellers. The buyers in this environment spend a considerable amount of time both identifying trustworthy sellers and determining the final purchase price of the items. In this embodiment, a process is performed to apply filters to identify a group of sellers (e.g., trustworthy sellers or sellers meeting some other criteria). Filters are also used to identify fixed price items that are being sold by the identified group of sellers. An elite network-based transaction facility is then created to include the fixed price items sold by the trustworthy sellers, for example. As a result, consumers who are interested in buying fixed price items from trustworthy sellers can do this with the elite network-based transaction facility. In other embodiments, other types of sellers and items are selected for the elite network based transaction facility with filters that use different selection criteria.

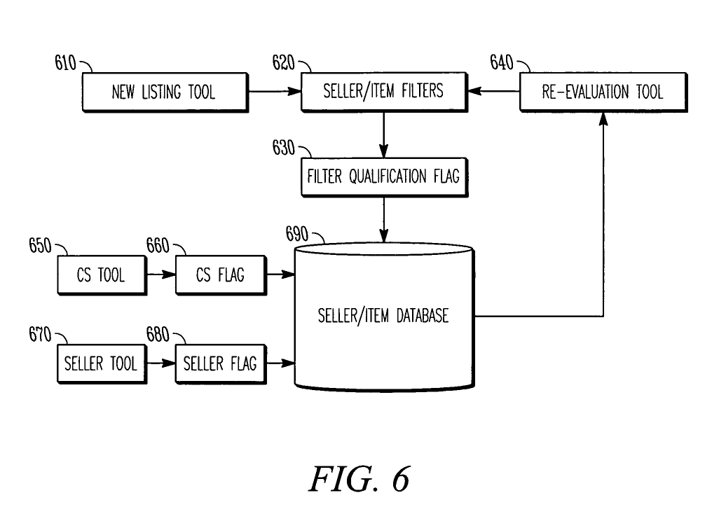

FIG. 6 illustrates another embodiment of a network-based transaction facility. In this embodiment, new listing tool 610 is used by a seller to place a new listing of an item into a seller/item database 690. The new listing is filtered by seller/item filters 620 to determine whether the seller and the item satisfy the criteria for listing the item in the elite transaction facility. A filter qualification flag 630 is generated by the seller/item filters 620 to identify whether the item is qualified or disqualified from the elite transaction facility. The listing for the item, and the associated filter qualification flag, are added to the seller/item database 690. (In another embodiment, the filter qualification flag may be located in a different table or record). The listings for items that are currently stored in seller/item database 690 can be periodically re-evaluated for eligibility on the elite transaction facility using re-evaluation tool 640. The re-evaluation tool 640 retrieves each listing from seller/item database 690 and applies the listing to seller/item filters 620. A new filter qualification flag 630 is generated for the item, and stored in seller/item database 690. Other tools may also be used to determine whether an item is qualified to be listed in the elite transaction based facility. For example, a customer support tool 650 can be used by a customer support department to create a customer support flag 660 that qualifies or disqualifies a specific item or seller, regardless of the status of the filter qualification flag 630. Similarly, a seller tool 670 can be used to create a seller opt-out flag 680 to allow a seller to disqualify his or her items from the elite transaction facility, regardless of the status of the filter qualification flag 630.

The filter qualification flag 630, in some embodiments, includes both a seller qualification flag and an item qualification flag. When the seller qualification flag is set to qualified, this indicates that the seller/item filters 620 have qualified the seller for participation in the elite transaction facility based on the seller filters and corresponding filtering criteria. Examples of seller filters include feedback levels and payment methods.

For example, if the seller/item filters 620 include a seller reputation filter (e.g., a feedback filter), a specific reputation characteristic (e.g., positive feedback level) is selected as a qualifying criterion. In one embodiment, the seller's positive feedback must meet or exceed the specified threshold level to qualify for the elite facility based on this filter. The feedback filter can also be expressed as a percentage of positive feedback. For example, a specific percentage of positive feedback is selected as a threshold for qualifying for the elite facility. Another example of a reputation filter is a public profile feedback filter. To qualify with this filter, the seller must have his or her feedback information available to the public.

A business seller framework (BSF) can also be used as a seller filter by seller/item filters 620. For example, this filter can use a seller's registration type to determine whether the seller qualifies for the elite transaction facility. When this filter is applied, a specific registration type or types are provided as the criteria for qualifying, selecting from BSF values such as Business Account, Personal Account, and Not specified. Using this filter, a seller's registration type must match one of the specified values to be qualified for the elite facility.

A third party payment account (such as a PayPal account for example) can also be used as a seller filter by seller/item filters 620. For example, the elite transaction facility can use a seller's registration status with the third party payment system to qualify sellers for the elite transaction facility. When this filter is applied, specific registration criteria are used as the threshold for qualifying, such as the account type (whether personal, business, or premier for example) and the account status (whether the account is in good standing). Also, a combined payments filter can identify sellers allowing combined payments as qualified for the elite transaction facility.

These seller filters are described as examples, and are not an exhaustive list. Other filters and other criteria can be used by seller/item filters 620 to select sellers that are qualified to participate in the elite transaction facility. In some embodiments, any filter that uses one or more criteria to select a subset of sellers from the complete set of sellers that are participating in the transaction based facility is a seller filter that can be used to select sellers to participate in the elite transaction facility.

In some embodiments, the filter qualification flag 630 includes an item qualify flag that indicates that the seller/item filters 620 have qualified the item for participation in the elite transaction facility based on item filtering criteria at that time. Examples of item filters used in seller/item filters 620 include item price, payment method and item condition. An example of an item filter is a payment method filter that identifies items that are configured to accept certain payment methods, such as a credit card or a third party account such as PayPal. A shipping cost filter identifies items that have specified shipping costs. A return policy filter is used to select items that meet minimum return policy criteria.

Other item filters, such as item picture, minimum or maximum buy it now price, charity, and item location filters for example, can also be used to select items that are allowed to participate in the elite facility. The item filters can also be used to exclude certain items from the elite facility. For example, item filters can identify items listed in auctions or in certain product or service categories (e.g., a real estate category), and exclude these items from the elite facility.

In addition to the filter qualification flags 630 that are created by the seller/item filters 620, other flags can be created to qualify or disqualify a seller or an item or both from the elite transaction facility. The flags include a customer support (CS) flag 660, and a seller opt-out flag 680.

In some embodiments, the customer support flag 660 is a seller disqualification flag that indicates that the customer support tool 650 has disqualified the seller and his or her items from the elite transaction facility, regardless of any other seller or item qualification flags. For example, a third party (e.g., a customer support representative for the transaction facility) can determine, without the use of seller/item filters 620, that a seller is excluded and disqualified from participation in the elite transaction facility. The customer support representative then uses customer support tool 650 to set the customer support flag 660 to disqualify that seller. This flag 660 is added to the information about the seller in the seller/item database 690. The elite transaction facility recognizes the CS disqualification flag for the seller in the database 690. If the seller is part of the elite transaction facility, then the seller is removed from the elite transaction facility. If the seller is not a part of the elite transaction facility, then the seller/item filters 620 will not be applied to the seller and his or her items by new listing tool 610 or re-evaluation tool 640, and the seller is not added to the elite transaction facility.

Similarly, the customer support representative can use the customer support tool 650 to allow a specific seller to participate in the elite facility, even though the seller is not selected by the seller and item filters. For example, by setting the customer support flag 660 to qualified, the customer support has qualified the seller for the elite transaction facility, regardless of the status of any other flags.

The customer support representative can also use customer support tool 650 disqualify an individual item from being sold on the elite facility by setting the customer support flag 660 to indicate a status of item force-out. When this status is set for an item, the seller may still be allowed to display other items on the elite transaction facility, provided that the seller is otherwise qualified to participate in the elite transaction facility.

The seller opt-out flag 680 indicates that a seller has disqualified his or her items from the elite transaction facility, regardless of the status of any other flags. For example, if a seller wishes to have items displayed only in the transaction based facility, and not in the elite transaction facility, the seller can use seller tool 670 to set this flag so that the seller/item filters 620 are not applied to the seller or to his or her items, and the seller is removed from the elite transaction facility. In some embodiments, setting the seller opt-out flag will globally opt the seller out of all elite transaction facility sites. In some embodiments, the seller opt-out flag can be set for a particular elite transaction facility, so that the seller is removed from the particular elite transaction facility but remains in other elite transaction facilities.

In one embodiment, the qualification flags may have a relative precedence. For example, the relative precedence of the qualification flags may be customer service seller disqualification flag, seller opt-out flag, customer service item disqualification flag, customer service item qualification flag, seller qualification flag, and item qualification flag. In this example embodiment, the customer service seller disqualification flag has the highest precedence, so that if this flag is set to disqualify the seller, then the seller and all of the seller's items are disqualified from the elite transaction facility, regardless of the status of the rest of the flags.

In one embodiment, the qualification flags such as the item and user flags may be flags on a particular item or user. The qualification flags may be stored along with other data about the item or user in seller/item database 690. In other embodiments the qualification flags may be manifested via a separate record or table or by storing the flag data in a separate database or file. In one embodiment, the network based transaction facility and the elite transaction facility occupy separate domains. For example, the network based transaction facility can occupy www.marketplace.com and the elite transaction facility can occupy www.elitemarketplace.com. In some embodiments, the network based transaction facility is associated with one or more network based transaction facility application programs, and the elite transaction facility is associated with one or more elite transaction facility application programs. In some embodiments, the seller and item data for the network based transaction facility is stored in a network based transaction facility database, and the seller and item data for the elite transaction facility is stored in an elite transaction database. In some embodiments, the sellers and items that are allowed to participate on the elite transaction facility are a subset of the sellers and items that participate on the network based transaction facility.

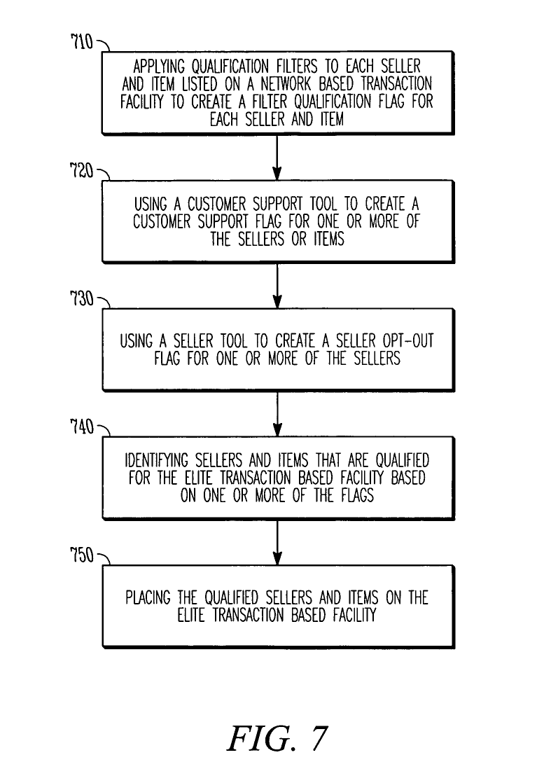

FIG. 7 illustrates an example embodiment of a process that uses seller and item filters to select sellers and items that are qualified to participate in an elite transaction facility. At 710, qualification filters are applied to each seller and item listed on a network based transaction facility to create a filter qualification flag for each seller and item. At 720, a customer support tool is used to create a customer support flag for one or more of the sellers or items. At 730, a seller tool is used to create a seller opt-out flag for one or more of the sellers. At 740, sellers and items that are qualified for the elite transaction based facility are identified based on one or more of the flags. At 750, the qualified sellers and items are placed on the elite transaction based facility.

### Computer System

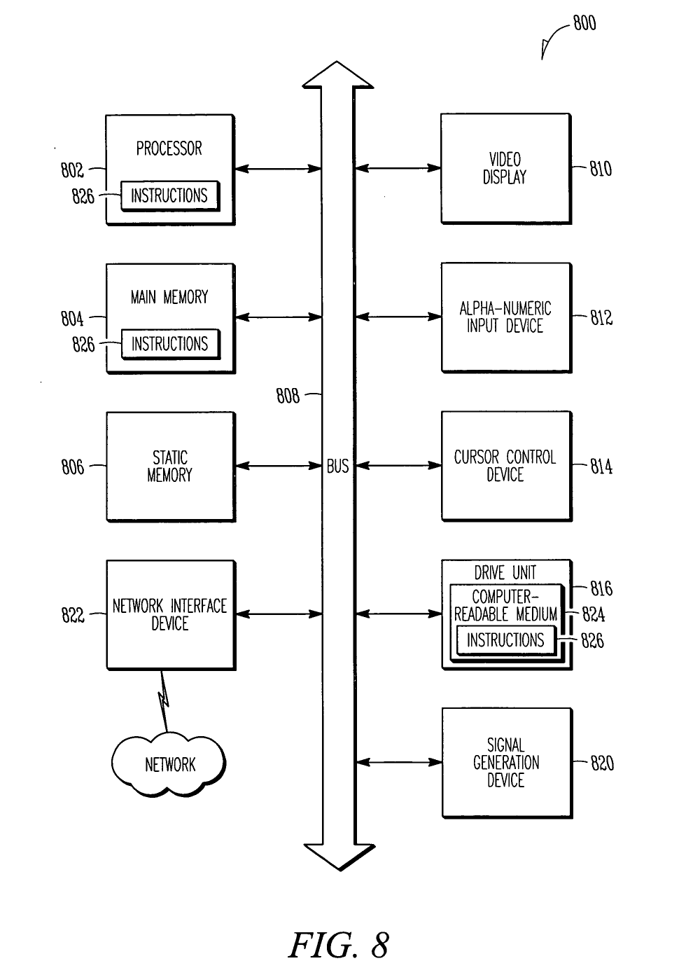

FIG. 8 shows a diagrammatic representation of a machine in the example form of a computer system 800 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 800 includes a processor 802, a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alpha-numeric input device 812 (e.g. a keyboard), a cursor control device 814 (e.g. a mouse), a disk drive unit 816, a signal generation device 820 (e.g. a speaker) and a network interface device 822.

The disk drive unit 816 includes a machine-readable medium 824 on which is stored a set of instructions (i.e., software) 826 embodying any one, or all, of the methodologies described above. The software 826 is also shown to reside, completely or at least partially, within the main memory 804 and/or within the processor 802. The software 826 may further be transmitted or received via the network interface device 822. For the purposes of this specification, the term “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals.

Thus, a system and method for order item and seller filters in a network-based transaction facility have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. A method comprising:
applying qualification filters to each item listed on a network based transaction facility to identify one or more qualified items; and
placing the qualified items on a network based elite transaction facility.

2. The method of claim 1, wherein applying qualification filters further comprises:
applying seller qualification filters to one or more sellers listed on the network based transaction facility to identify one or more qualified sellers.

3. The method of claim 1, wherein placing the qualified items on the network based elite transaction facility further comprises:
creating a filter qualification flag for each item;
identifying items having a filter qualification flag set to qualified; and
placing items having the filter qualification flag set to qualified on the network based elite transaction facility.

4. The method of claim 3, wherein placing the qualified items further comprises:
creating a customer support flag for each item;
identifying items having a customer support flag set to qualified; and
placing items having the customer support flag set to qualified on the network based elite transaction facility.

5. The method of claim 4, further comprising:
identifying items having the customer support flag set to disqualified; and
removing items having the customer support flag set to disqualified from the network based elite transaction facility.

6. The method of claim 1, further comprising:
creating a seller opt-out flag for one or more sellers;
identifying items of sellers having the seller opt-out flag set to disqualified; and
removing the identified items from the network based elite transaction facility.

7. The method of claim 1, further comprising:
re-applying the qualification filters to the items listed on the network based facility.

8. The method of claim 1, wherein said network-based transaction facility is an online auction facility.

9. The method of claim 1, wherein the network based transaction facility has a first domain, and the elite transaction facility has a second domain.

10. A system comprising:
a processor that applies qualification filters to each item listed on a network based transaction facility to identify one or more qualified items, and places the qualified items on a network based elite transaction facility.

11. The system of claim 10, wherein the processor applies qualification filters by applying seller qualification filters to the one or sellers listed on the network based transaction facility to identify one or more qualified sellers.

12. The system of claim 10, wherein the processor places the qualified items by creating a filter qualification flag for each item, identifying items having a filter qualification flag set to qualified, and placing items having the filter qualification flag set to qualified on the network based elite transaction facility.

13. The system of claim 12, wherein the processor places the qualified items by creating a customer support flag for each item, identifying items having a customer support flag set to qualified, and placing items having the customer support flag set to qualified on the network based elite transaction facility.

14. The system of claim 13, wherein the processor is configured to remove disqualified items by identifying items having the customer support flag set to disqualified and removing items having the customer support flag set to disqualified from the network based elite transaction facility.

15. The system of claim 10, wherein the processor is further configured to create a seller opt-out flag for one or more sellers, identify items of sellers having the seller opt-out flag set to disqualified, and remove the identified items from the network based elite transaction facility.

16. The system of claim 10, wherein the processor is further configured to re-apply the qualification filters to the items listed on the network based facility.

17. A computer readable medium storing a program of instructions which, when executed by a processing system, causes the processing system to perform a method comprising:
applying qualification filters to each item listed on a network based transaction facility to identify one or more qualified items; and
placing the qualified items on a network based elite transaction facility.

18. The computer readable medium of claim 17, wherein applying qualification filters further comprises:
applying seller qualification filters to the one or more sellers listed in the network based transaction facility to identify one or more qualified sellers.

19. The computer readable medium of claim 17, wherein placing the qualified items further comprises:
creating a filter qualification flag for each item;
identifying items having a filter qualification flag set to qualified; and
placing items having the filter qualification flag set to qualified on the network based elite transaction facility.

20. The computer readable medium of claim 19, wherein placing the qualified items further comprises:
creating a customer support flag for each item;
identifying items having a customer support flag set to qualified; and
placing items having the customer support flag set to qualified on the network based elite transaction facility.

21. The computer readable medium of claim 20, further comprising:
identifying items having the customer support flag set to disqualified; and
removing items having the customer support flag set to disqualified from the network based elite transaction facility.

22. The computer readable medium of claim 17, further comprising:
creating a seller opt-out flag for one or more sellers;
identifying items of sellers having the seller opt-out flag set to disqualified; and
removing the identified items from the network based elite transaction facility.

23. The computer readable medium of claim 17, further comprising:
re-applying the qualification filters to the items listed on the network based facility.
